(19) United States
(12) Patent Application Publication
(10) Pub. No.: US 2007/0280282 A1
(43) Pub. Date: Dec. 6, 2007

(54) INDOOR DIGITAL MULTIMEDIA NETWORKING

(76) Inventors: Shing-Wu P. Tzeng, Fountain Valley, CA (US); Peter Pak, Irvine, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/611,116

(22) Filed: Dec. 14, 2006

Related U.S. Application Data
(60) Provisional application No. 60/811,313, filed on Jun. 5, 2006.

(51) Int. Cl. H04J 15/00

(52) U.S. Cl. 370/464

(57) ABSTRACT

An indoor digital multimedia network includes a centralized set of digital multimedia sources, such as a DVD player, a video game console, a personal computer console, a media center, and a set-top television box. The digital multimedia source set is operatively connected to output devices (e.g., television, computer monitor, projector, audio speaker) located in locations remote from the digital multimedia source set. The digital multimedia sources and output devices are operatively connected in a visually seamless manner through the use of substantially transparent optical fiber cables.

### CROSS-REFERENCE TO RELATED APPLICATIONS

The present application claims priority, under 35 U.S.C. §119, of U.S. Provisional Patent Application No. 60/811,313, filed on Jun. 5, 2006 and entitled “Server-to-Terminal via Single Optical Fiber”. Further, the present application contains subject matter that may be related to subject matter contained in the following commonly owned co-pending applications: U.S. patent application Ser. No. 11/173,409, filed on Jun. 30, 2005 and entitled “Bi-Directional Transmission Module Using Single Optical Fiber”; U.S. patent application Ser. No. 11/406,558, filed on Apr. 18, 2006 and entitled “Protocol for Uncompressed Multimedia Data Transmission”; U.S. patent application Ser. No. 11/406,875, filed on Apr. 18, 2006 and entitled “EDID Pass Through via Serial Channel”; U.S. patent application Ser. No. 11/465,693, filed on Aug. 18, 2006 and entitled “Latchless, Push-Pull Optical Fiber Connector with Spring Loaded Ferrule”; and U.S. patent application Ser. No. 11/423,381, filed on Jun. 9, 2006 and entitled “Integrated Remote Control Sampling”, each of which are hereby incorporated by reference.

### BACKGROUND

“Digital multimedia” applications are those in which information, generally in the form of video and/or audio, is digitally conveyed. Such digital multimedia applications are well recognized as being superior to their analog counterparts. For example, the picture quality of a television system capable of receiving and playing a digital broadcast is generally clearer than that of a television system receiving and playing an analog version of the broadcast. Further, for example, digital audio is considered to be of higher acoustic quality than analog audio. It follows that there is high demand for digital multimedia solutions.

The use of digital multimedia systems is prevalent in indoor environments, such as homes and businesses (e.g., restaurants, bars, airports, sports arena, sports stadium, entertainment complexes). Now referring to FIG. 1, it shows a typical indoor environment 10 having four separate rooms 12, 14, 16, 18, where each room 12, 14, 16, 18 contains a digital multimedia source 20, 22, 24, 26, respectively, and a digital multimedia output device 28, 30, 32, 34. As used herein, a “digital multimedia source” is any system, unit, or device that reads some media for generating digital video and/or audio, and a “digital multimedia output device” is any system, unit, or device that is capable of outputting or delivering digital multimedia content to an end user. For example, digital multimedia source 20 in room 12 may be a “set-top” television box for receiving digital television broadcasts (the media), which are rendered with a digital television 28. Digital multimedia source 22 in room 14 may be a gaming console that reads video game media to enable video game play via a television screen 30. Digital multimedia source 24 in room 16 may be a digital music player (e.g., a compact disc (CD) player) that outputs audio to a set of speakers 32. Digital multimedia source 26 in room 18 may be a digital movie player (e.g., a digital video disc (DVD) player) that outputs digital video signals for rendering on a high-definition television 34. Although not specifically shown in FIG. 1, various other digital multimedia sources and output devices are known and can be used in the indoor environment 10. For example, another type of digital multimedia source could be a personal computer that delivers digital multimedia content via a computer monitor and/or computer speakers.

As apparent from the depiction shown in FIG. 1, a digital multimedia source must typically be located in the same room (or more generally, in the same vicinity) as the digital multimedia output device(s) used to deliver the digital multimedia content generated from the digital multimedia source. Thus, for example, a user has access to multimedia sources in the same room or vicinity, but not to all sources in all rooms (e.g., it is difficult for a user to control a personal computer (PC) in one room from a television in another room). This restriction is primarily a function of connectivity limitations. In other words, for example, in room 18, the digital movie player 26 must be in close enough proximity to the high-definition television 34 so as to allow these two components to be physically connected by one or more signal wires in a manner that is relatively seamless to the eye. When the digital multimedia source and its corresponding output device(s) are moved further apart from each other, it becomes more difficult to hide unsightly wires needed to connect the digital multimedia source and output device(s). In the case where a user demands an aesthetically pleasing indoor environment in which wires are not visible, he/she will likely to have to pay a considerable premium for a pre-wired and/or custom digital multimedia installation. Moreover, longer distance between the source and output necessarily requires longer wires, thereby adding to the overall cost of the digital multimedia solution.

### SUMMARY

According to at least one aspect of one or more embodiments of the present invention, an apparatus includes circuitry that is arranged to multiplex compressed or uncompressed digital data. The apparatus further includes circuitry that is arranged to convert the multiplexed digital data to a signal capable of being transmitted over a single optical fiber. Moreover, the circuitry includes a connector that is operatively connected to the conversion circuitry and is arranged to couple the signal to the single optical fiber.

According to at least one other aspect of one or more embodiments of the present invention, a system includes a digital multimedia source arranged to generate a digital signal in response to reading a multimedia content medium. The system further includes a dongle device operatively connected to the digital multimedia source and arranged to convert the digital signal to an optical signal, where the dongle device comprises a connector arranged to couple the optical signal to a substantially transparent optical fiber cable.

According to at least one other aspect of one or more embodiments of the present invention, a method of handling digital multimedia content includes inputting a digital signal from a digital multimedia source. The method further includes multiplexing the digital signal and converting the digital signal to an optical signal. Moreover, the method includes coupling the optical signal to a substantially transparent optical fiber cable for transmission of the optical signal to a location of an output device.

According to at least one other aspect of one or more embodiments of the present invention, a method of handling digital multimedia content includes: reading a digital content medium; generating with a digital multimedia source a digital signal in response to the reading; converting the digital signal to an optical signal; coupling the optical signal to a substantially transparent optical fiber cable, where the optical fiber cable is capable of carrying the optical signal to an output device disposed in a location remote from a location of the digital multimedia source; receiving from the optical fiber cable a user control signal initiated by a user in response to digital multimedia content rendered by the output device; and modifying the digital signal with the digital multimedia source in response to the user control signal.

The features and advantages described herein are not all inclusive, and, in particular, many additional features and advantages will be apparent to those skilled in the art in view of the following description. Moreover, it should be noted that the language used herein has been principally selected for readability and instructional purposes and may not have been selected to circumscribe the present invention.

### BRIEF DESCRIPTION OF DRAWINGS

FIG. 1 shows a typical digital multimedia implementation.

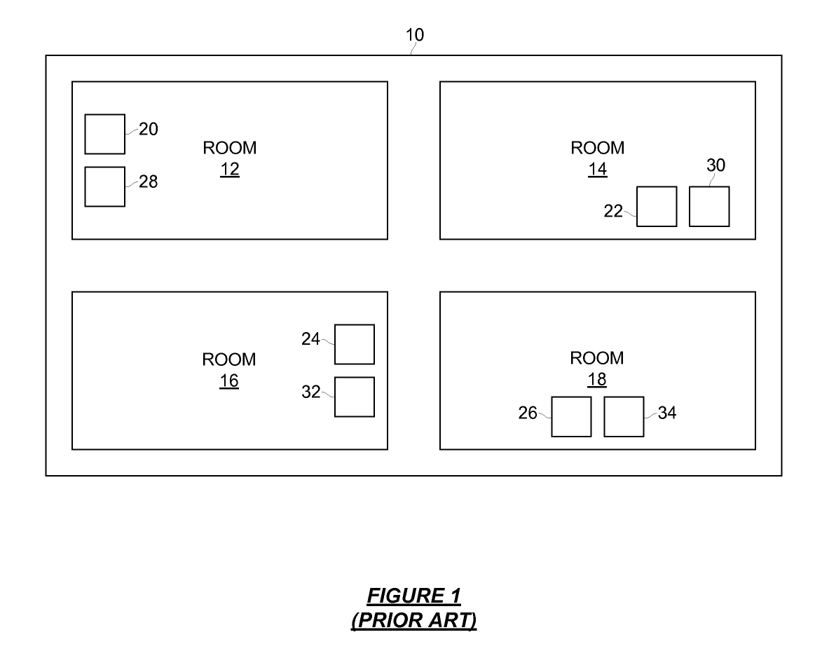

FIG. 2 shows an indoor digital multimedia network in accordance with an embodiment of the present invention.

FIGS. 3A and 3B show cutaway pictures of a substantially transparent optical fiber cable in accordance with an embodiment of the present invention.

FIG. 4 shows a portion of an indoor digital multimedia network in accordance with an embodiment of the present invention.

FIG. 5 shows a portion of an indoor digital multimedia network in accordance with an embodiment of the present invention.

FIG. 6 shows a portion of an indoor digital multimedia network in accordance with an embodiment of the present invention.

FIG. 7 shows a portion of an indoor digital multimedia network using a wireless optical link in accordance with an embodiment of the present invention.

Each of the figures referenced above depict an embodiment of the present invention for purposes of illustration only. Those skilled in the art will readily recognize from the following description that one or more other embodiments of the structures, methods, and systems illustrated herein may be used without departing from the principles of the present invention.

### DETAILED DESCRIPTION

In the following description of embodiments of the present invention, numerous specific details are set forth in order to provide a more thorough understanding of the present invention. However, it will be apparent to one skilled in the art that the present invention may be practiced without one or more of these specific details. In other instances, well-known features have not been described in detail to avoid unnecessarily complicating the description.

Embodiments of the present invention generally relate to a digital multimedia source and delivery system that is particularly suitable for indoor use. As such, one or more of the embodiments described below can be referred to as being associated with an “indoor digital multimedia networking” solution. Particularly, in one or more embodiments, a plurality of digital multimedia sources are co-located in the same area of an indoor environment and are connected, via substantially transparent optical fiber cable, to digital multimedia output devices located in different areas of the indoor environment.

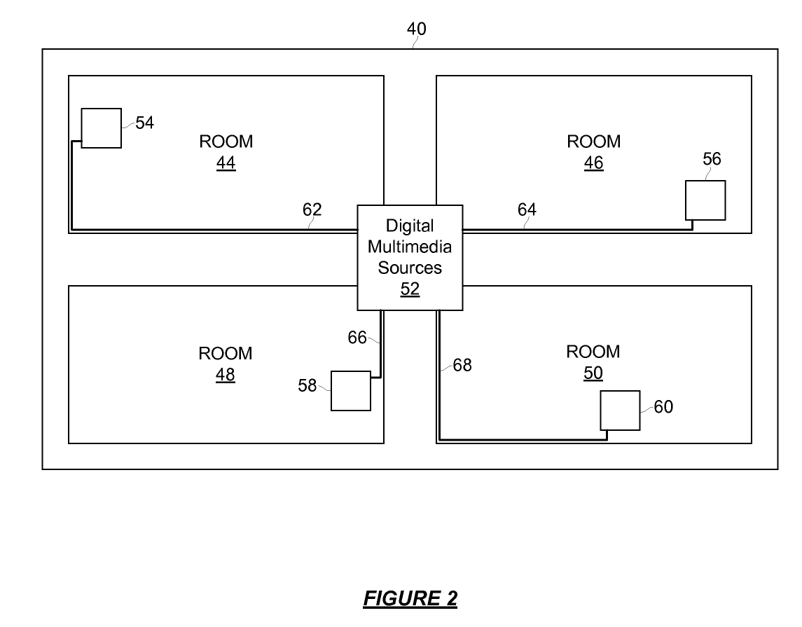

FIG. 2 shows an exemplar digital multimedia network in accordance with an embodiment of the present invention. The digital multimedia network is deployed in an indoor environment 40. The indoor environment 40 may be, for example, a home, a business, a government office, or a school. In general, the indoor environment 40 may be any environment in which digital multimedia content can be delivered in an indoor setting.

The indoor environment 40 is shown as having a plurality of rooms 44, 46, 48, 50. A “room,” as used herein, refers to an area of the indoor environment 40, and as such, the rooms 44, 46, 48, 50 represent different areas of the indoor environment 40. In the case where the indoor environment 40 is a home, the plurality of rooms 44, 46, 48, 50 may represent any combination of, for example, a kitchen, a bedroom, a family room, a study room, a game or entertainment room, an office, a living room, a dining room, a den, etc. In the case where the indoor environment 40 is a business, the plurality of rooms 44, 46, 48, 50 may represent any combination of, for example, a lobby/reception area, an office, a lounge, and a conference room.

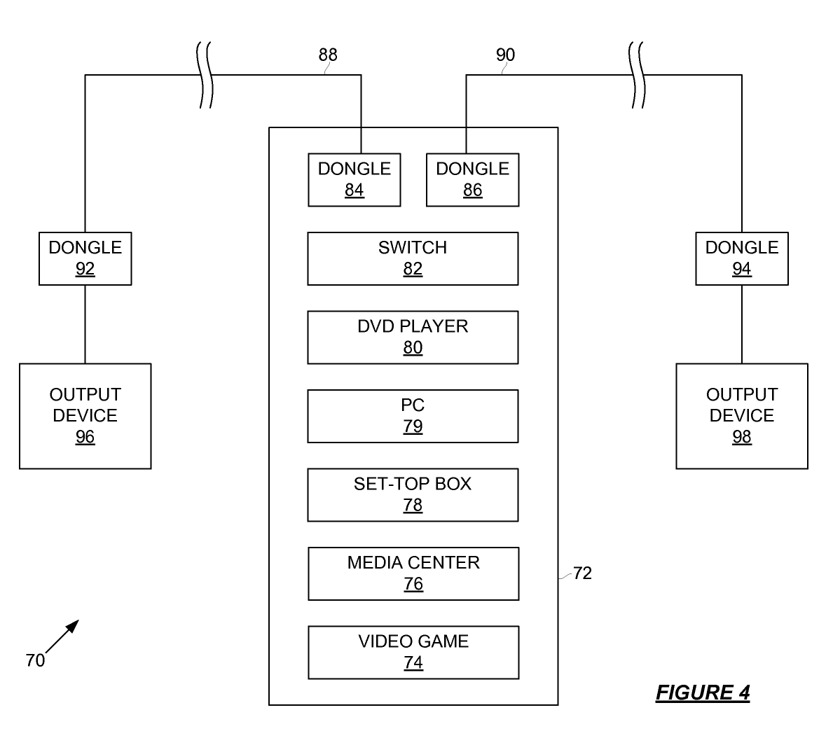

Still referring to FIG. 2, located in some area of the indoor environment 40 is a centralized set of digital multimedia sources 52. In one or more embodiments, the digital multimedia source set 52 includes a plurality of digital multimedia sources (not individually shown in FIG. 2, but shown in FIG. 4 described below). Any one of the digital multimedia sources in the set 52 may be, for example, an audio receiver, a video receiver, a computer system console (e.g., a computer system chassis supporting processing circuitry, memory, and a hard drive), a DVD player, a CD player, a “set-top” television box, or a video game console.

The digital multimedia source set 52 is referred to as being “centralized” in that the components of the digital multimedia source set 52 are located in the same area of the indoor environment 40. In other words, for example, the various individual digital multimedia sources in the set 52 are not located in different rooms of the indoor environment 40. The use of the term “centralized” does not limit the particular location of the digital multimedia source set 52 within the indoor environment 40. For example, the digital multimedia source set 52 may be located in any one of the rooms 44, 46, 48, 50 or another area of the indoor environment 40 not particularly represented in FIG. 2.

Still referring to FIG. 2, the digital multimedia source set 52 is operatively connected to a plurality of digital multimedia output devices 54, 56, 58, 60 located in the rooms 44, 46, 48, 50, respectively. Any one of the digital multimedia output devices 54, 56, 58, 60 may be, for example, a television (e.g., a flat-panel liquid crystal display (LCD) television, a flat-panel plasma television, a high-definition television (HDTV)), a projector, a speaker system, or a computer monitor.

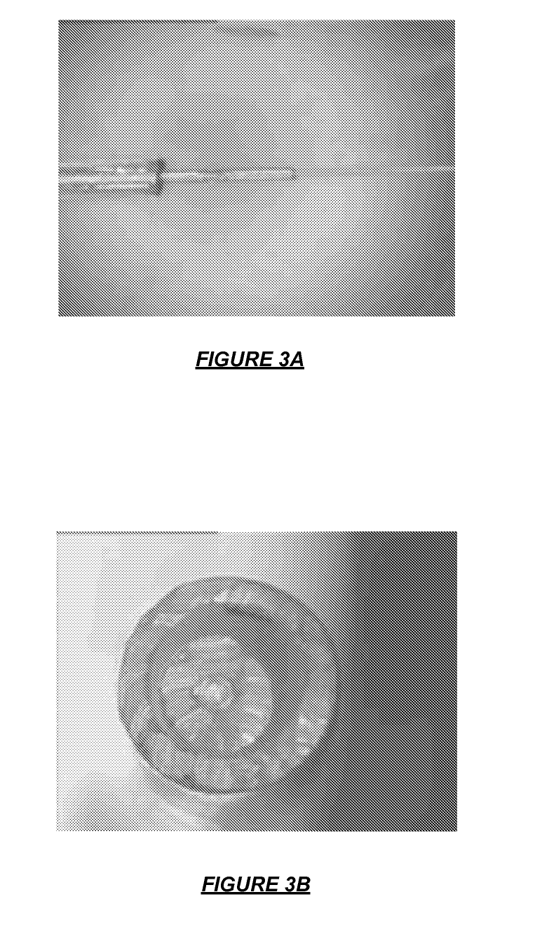

The digital multimedia source set 52 is operatively connected to the plurality of digital multimedia output devices 54, 56, 58, 60 by optical fiber cables 62, 64, 66, 68. Particularly, in one or more embodiments, the optical fiber cables 62, 64, 66, 68 are substantially transparent or clear when placed along a substantially white wall or ceiling. A single optical fiber is virtually invisible, especially when placed against a white backdrop (e.g., wall, ceiling). In one or more embodiments, an optical fiber cable is said to be substantially transparent in that the jacket that surrounds the single optical fiber is substantially clear, so as to render the optical fiber cable itself almost unnoticeable when placed against a white (or substantially white) backdrop. Further, in one or more embodiments, the optical fiber cable may be constructed of a multi-mode optical fiber. The core fiber may have a 50 μm or 62 μm core diameter with standard cladding (125 μm diameter) and buffer (250 μm diameter). The fiber may be coated with a clear PVC jacket or other clear polymer acrylic to a preferred cable diameter. As such, the substantially transparent optical fiber cables 62, 64, 66, 68 (side and cross-section cutaway pictures of a substantially transparent optical fiber cable taken using a microscope are respectively shown in FIGS. 3A and 3B) used in one or more embodiments are virtually invisible to the non-suspecting human eye. In other words, unless someone is specifically trying to notice the presence of the optical fiber cables 62, 64, 66, 68, the optical fiber cables 62, 64, 66, 68 virtually blend in with the walls and ceilings along which they are placed in the implementation connecting the digital multimedia source set 52 with one or more of the digital multimedia output devices 54, 56, 58, 60. Such use of substantially transparent optical fiber cables allows for an aesthetically pleasing solution for connecting remotely located digital multimedia components.

Although a substantially transparent optical fiber cable may be of any thickness in one or more embodiments, it may make practical and/or aesthetical sense to use relatively thin substantially transparent optical fiber cables. For example, in one or more embodiments, the thickness of a substantially transparent optical fiber cable may be equal to or around 900 μm, and in one or more other embodiments, the thickness may be equal to or around 1.6 mm. Moreover, the thickness of the substantially transparent optical fiber cable may depend on factors such as desired rigidity and/or desired level of protection from environmental influences (e.g., heat, moisture, pressure, bending).

The use of the substantially transparent optical fiber cables 62, 64, 66, 68 may be advantageous for many reasons. For example, prior art digital visual interface (DVI-D) cables only deliver digital video data. Moreover, DVI signals are subject to a “digital cliff” phenomenon by which signals become unrecoverable at certain distances. Prior art high-definition multimedia interface (HDMI) cables, which are capable of delivering digital video and audio data, are also subject to the “digital cliff” phenomenon. Prior art component video cables, which are often used for video game systems, only deliver analog video, and as such, require digital conversion, which can affect performance.

The substantially transparent optical fiber cables 62, 64, 66, 68 also have advantages over prior art multi-channel digital audio cables. For example, data transmission over prior art digital coaxial cables degrades significantly at a relatively short distance. Transmission distance is similarly limited with prior art Toslink cables.

Further, the use of substantially transparent optical fiber cables 62, 64, 66, 68 in one or more embodiments offers benefits over digital networking cables and wireless protocols. For example, video transmission over prior art Ethernet cables, which deliver digital data using local area network (LAN) cabling, requires compression and packetization and generally does not support content protection (e.g., High-Bandwidth Digital Content Protection (HDCP)). Video transmission over prior art universal serial bus (USB) cables requires compression and also generally does not support content protection (e.g., HDCP). Moreover, transmission distance is limited with USB cables. Similarly, digital data delivery using IEEE 1394 standard cables requires compression, generally does not support content protection (e.g., HDCP), and is restrictively distance sensitive. In regard to wireless transmissions, WiFi (e.g., IEEE 802.11x), although offering a transparent solution, is subject to potentially noticeable bandwidth constraints, interference (e.g., due to walls, metal beams, other wireless networks), and security threats.

In regard to bandwidth, those skilled in the art will note that bandwidth, in terms of bits per second (BPS), may be computed as a product of resolution, frame refresh rate, number of colors, and number of color bits (BPS=resolution*frame refresh rate*number of colors*number of color bits). Thus, for example, for 1080i uncompressed digital video transmission in 8-bit color and at a refresh rate of 30 frames per second, the required bandwidth is equal to 1920*1125*30*3*8, or 1.555G BPS. For 720p uncompressed digital video transmission in 8-bit color and at a refresh rate of 60 frames per second, the required bandwidth is equal to 1280*858*60*3*8, or 1.581G BPS. The bandwidth is increased even further when adding, for example, audio channels and control information. A common 8B/10B encoding scheme in serial link transmission requires extra overhead in bandwidth. The following table includes some popular video format and bandwidth needed.

| Video format | Color depth | Raw data rate | overhead | BW needed |
|---|---|---|---|---|
| 720 p | 8 bit | 1.58 GBPS | 25% | ~2.0 GBPS |
| 1080i | 8 bit | 1.55 GBPS | 25% | ~2.0 GBPS |
| 1080p | 12 bit | 4.66 GBPS | 25% | ~5.9 GBPS |

Prior art copper wire solutions are limited in transmitting high bandwidth, especially at distances over about 10 meters. To support higher bandwidth, the copper wire thickness (gage) may have to be increased, which leads to added cost and handling problems due to the higher thickness. Moreover, the use of noticeably thick copper wires in an indoor environment may not be very aesthetically pleasing. Accordingly, the use of relatively thin, substantially transparent, high-bandwidth optical fiber affords various advantages in terms of bandwidth, distance, and aesthetics.

Further, the use of optical fiber in accordance with one or embodiments provides the ability to transmit uncompressed data. While multimedia content providers prefer uncompressed transmission in order to prevent copying, compression results in resolution loss and potential video discontinuity. Thus, there is a preference to use uncompressed data transmission. With optical fiber, both compressed and uncompressed data transmission are supported.

In view of some of the shortcomings of prior art data transmission mechanisms described above, the substantially transparent optical fiber cables 62, 64, 66, 68, in one or more embodiments, allow for compressed or uncompressed data transmission, simultaneous video, audio, and control signal transmission, and/or high bandwidth transmission. Further, for example, in one or more embodiments, the optical fiber cables 62, 64, 66, 68, in addition to being substantially transparent as described above, may be fairly thin (e.g., 0.5 mm) and considerably thinner than prior art cabling. Moreover, it is noted that the cost of the optical fiber cables 62, 64, 66, 68 may be lower than that of prior art multi-pin copper or gold cabling.

In one or more embodiments, one or more of the optical fiber cables 62, 64, 66, 68 are formed of a single optical fiber that is used to carry digital multimedia content and control signals associated therewith. The use of a single optical fiber for digital multimedia transmissions is described in U.S. patent application Ser. No. 11/173,409, referenced above.

Further, in one or more embodiments, the transmission of digital multimedia content from the digital multimedia source set 52 to the various digital multimedia output devices 54, 56, 58, 60 is done in an uncompressed format. In other words, digital multimedia content is not compressed prior to being “pushed down” one of the optical fiber cables 62, 64, 66, 68. Those skilled in the art will note that by avoiding compression, various advantages may be achieved. For example, data compression results in at least some loss of data and/or resolution, and thus, by delivering digital multimedia content in uncompressed form, such data/resolution loss may be avoided. Also, the use of complex and time-consuming compression and decompression algorithms may be avoided. Techniques for uncompressed multimedia data transmission are described in U.S. patent application Ser. No. 11/406,558 and U.S. patent application Ser. No. 11/406,875, each referenced above.

FIG. 4 shows a portion of an exemplar digital multimedia network 70 in accordance with an embodiment of the present invention. A centralized digital multimedia source set 72 includes, for example, a video game system/console 74, a media center 76, a “set-top” television box 78, a personal computer console 79, and a DVD player 80. Further, although not shown in FIG. 4, a digital multimedia source may be a camera, such as one used for security and/or surveillance purposes.

The centralized digital multimedia source set 72 may also include a switch 82 for multiplexing the various digital signals from the video game system/console 74, the media center 76, the “set-top” television box 78, the personal computer console 79, and the DVD player 80 to a certain number of outputs from the digital multimedia source set 72.

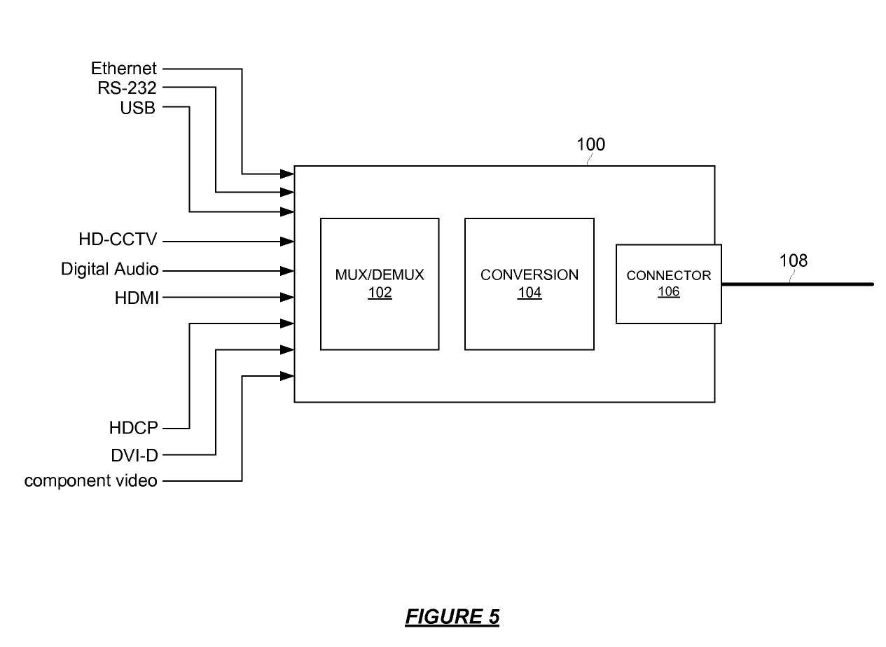

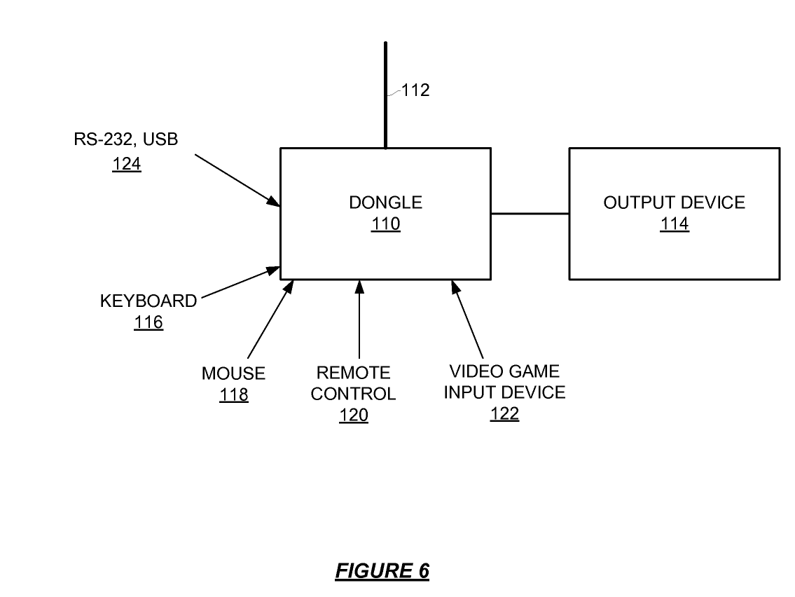

Also shown in FIG. 4 is that the digital multimedia source set 72 includes dongle devices 84, 86, which are further described below with reference to FIGS. 5 and 6. The dongle devices 84, 86 are connected to substantially transparent optical fiber cables 88, 90, respectively. In general, the dongle devices 84, 86 multiplex uncompressed digital video and/or audio signals received from the switch 82 and convert the multiplexed data for transmission along the optical fiber cables 88, 90.

Uncompressed video, audio, and/or control signals propagated along the optical fiber cables 88, 90 from the dongle devices 84, 86 are received at dongle devices 92, 94, respectively. It is noted that the dongle devices 92, 94 may be located in different areas of an indoor environment than are the dongle devices 84, 86. The dongle devices 92, 94 convert the multiplexed data from the optical fiber cables 88, 90 and demultiplex the signals for subsequent delivery to digital multimedia output devices (e.g., television, computer monitor, speakers) 96, 98. Further, it is noted that the optical signal carried by optical fiber cables may be a video signal that is content protected (e.g., in a digital rights management (DRM) scheme).

Referring again to the digital multimedia source set 72 shown in FIG. 4, the DVD player 80 may be a high-density or high-definition DVD (HD-DVD) device. In one or more other embodiments, the DVD player 80 may be capable of reading Blu-ray discs. The use of one or more of the substantially transparent optical fiber cables 88, 90 allows the DVD player 80 to be placed away from one or more of the digital multimedia output devices 96, 98. Such a technique may be useful, for example, when one of the digital multimedia output devices 96, 98 is desired to be wall-mounted with no room nearby to place the DVD player 80.

Further, the deployment of the digital multimedia network 70 as shown in FIG. 4 allows the video game system/console 74 to effectively become a multi-room game server. As further described below with reference to FIG. 6, using back-channel communication mechanisms enabled by the dongle devices 92, 94, it may be possible to feedback controller data from one room to the video game system/console 74, which may be located in another room. It is additionally noted that in one or more embodiments, uncompressed high definition decrypted video with digital rights management may be streamed from one room to another.

Moreover, use of one or more of the substantially transparent optical fiber cables 88, 90 allows an output from a video card of the personal computer console 79 to be inconspicuously sent a relatively long distance (e.g., from one side a home to another) to effectively render the personal computer console 79 as a multi-room server. In such a manner, the need to have a local machine in every room where computer access is desired may be avoided. Instead, in one or more embodiments, control signals provided by a user in response to computer content rendition at one or more of the digital multimedia output devices 96, 98 may be fed back to the single personal computer console 79, which may be located in a different room or area.

FIG. 5 shows an exemplar dongle device 100 in accordance with an embodiment of the present invention. The dongle device 100 is representative of any one or more of the dongle devices 84, 86, 92, 94 shown in FIG. 4. The dongle device 100 is shown as having a plurality of modules, where a “module,” as used herein, refers to any program, logic, functionality, and/or circuitry implemented in hardware and/or software. Particularly, the dongle device 100 has a mux/demux module 102 that is arranged to handle one or more of various types of signals. For example, as shown in FIG. 5, the dongle device 100 may effectively receive one or more of an Ethernet signal, an RS-232 signal, an USB signal, a digital audio signal, an HDMI signal, an HDCP signal, a DVI-D signal, a signal from a camera (e.g., closed circuit security/surveillance camera (HD-CCTV)) and a component video signal. The mux/demux module 102 is arranged to multiplex received uncompressed video, audio, and/or control signals.

The multiplexed data from the mux/demux module 102 is converted by a conversion module 104 to an optical signal. In other words, the multiplexed data is prepared by the conversion module 104 for optical fiber transmission. The conversion module 104 is operatively connected to a connector module 106 that couples the optical signal generated by the conversion module 104 to a substantially transparent optical fiber cable 108. More particularly, the connector module 106 couples the optical signal to a forward channel of a single optical fiber in the optical fiber cable 108. Examples of physical connectivity and optical signal coupling are described in U.S. patent application Ser. No. 11/173,409 and U.S. patent application Ser. No. 11/465,693, each referenced above.

It is noted that in one or more embodiments, the dongle device 100 may be integrated with or part of a digital multimedia source, as opposed to being externally connected via wire. In such a manner, the optical fiber cable can be directly coupled to the digital multimedia source.

As described above with reference to FIG. 4, data from a user located in one room can be fed back to a particular digital multimedia source located in another room. Now referring to FIG. 6, it shows a portion of an exemplar indoor digital multimedia network in which a dongle device 110 is arranged to receive user controls. For example, as shown in FIG. 6, the dongle device 110 may interface with any one or more of a keyboard 116, a mouse 118, a remote control 120, and a video game input device (e.g., a handheld controller/joystick) 122. The dongle device 110 takes signals received from the user and processes them for transmission along a substantially transparent optical fiber cable 112 back to a particular digital multimedia source, which may be located in an area different from that of where the dongle device 110 is located. More particularly, the dongle device 110 may convert back signals from the forward channel to an original format and combine signals for coupling to a backward channel of the single optical fiber.

Further, it is noted that audio sources may be at either end of the dongle device 110. Although a video source is usually at the transmission side of the dongle device 110 and a display device is at the receiver side of the dongle device 110, an audio source may be at a receiver side of the dongle device 110 to send audio signals back to the speaker on a transmission side of the dongle device 110. It is additionally noted that the dongle device 110 may receive additional inputs 124 (e.g., RS-232, USB).

Moreover, the dongle device 110 may be operatively connected to an output device 114 (e.g., a television), where the output device 114 is located in the same room or area as one or more of the input devices 116, 118, 120, 122. Thus, in other words, for example, the dongle device 110 may (i) receive uncompressed digital multimedia signals transmitted along the optical fiber cable 112, where these signals are used to deliver digital multimedia content via an output device 114 (e.g., a television), (ii) receive user control signals via the keyboard 116, the mouse 118, the remote control 120, and/or the video game input device 122, and (iii) pass the control signals back, along the optical fiber cable 112, to one or more particular digital multimedia sources (not shown) located in another room or area.

Further, it is noted that a typical optical HDMI link or HDMI switch may not tell a television what is being connected to it. In one or more embodiments, the system may be taught to identify the device name/model in addition to EDID. In other words, for example, the television may display what device is being connected to it upon operative connection of that device to the television.

It is additionally noted that any type of user input device may be used in conjunction with the dongle device 110. For example, aside from the input devices 116, 118, 120, 122 shown in FIG. 6, a voice command input device may be interfaced with the dongle device 110.

Still referring to FIG. 6, one or more of various techniques may be used for interfacing the user input devices 116, 118, 120, 122 with the dongle device 110. For example, in one or more embodiments, one of the user input devices 116, 118, 120, 122 may interface with the dongle device 110 by infrared (IR) communication. Further, for example, one of the user input devices 116, 118, 120, 122 may interface with the dongle device 110 via a USB cable (not shown), where a keyboard, mouse, and/or combination device may function through such an USB interface.

It is further noted that an IR “blasting” function may work in a broadcasting scheme, meaning that an IR signal may be sent to units having built-in IR sensors. Those units that are locked-in with correct code formats may then respond to control commands. Thus, in such a manner, units with built-in IR sensors may be connected in a digital multimedia network and controlled by a user without any special network protocol.

In the case of the remote control 120, in one or more embodiments, the remote control 120 may be programmed to control a plurality of different digital multimedia sources. For example, if a centralized set of digital multimedia sources includes a DVD player and a “set-top” television box, the remote control 120 may be programmed to control both of these sources. In such a manner, a user located in an area of an indoor environment away from digital multimedia sources which the user wishes to control may do so, via the dongle device 110 and optical fiber cable 114. For example, when a user is watching a publicly broadcast program on a television in his/her bedroom, he/she can then use the remote control 120 to switch the television to render a video game, a DVD movie, or the Internet, where such content is generated from digital multimedia sources (e.g., a video game console, a DVD player, and a personal computer console) co-located in another room. Further, in one or more embodiments, these same digital multimedia sources may either be simultaneously or sequentially accessed by another user in yet another room. Remote control sampling is described in U.S. patent application Ser. No. 11/423/381, referenced above.

Moreover, in the case of user signals provided via IR communication, the IR signals may be recovered at the location of the digital multimedia source set in a manner such that the IR signal is replicated and pointed at IR receivers of one or more of the various digital multimedia sources. Such an IR repeating mechanism may be necessary if one or more of the digital multimedia sources are capable of receiving user commands only via IR signaling and manual button presses.

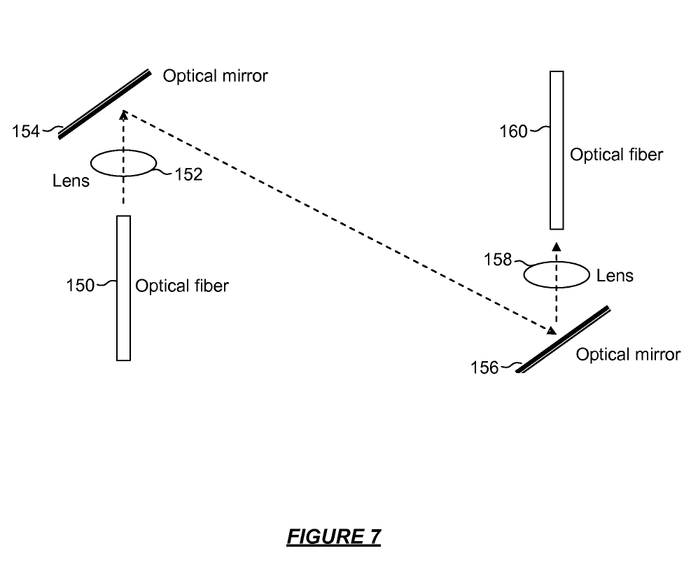

Further, in one or more embodiments, digital multimedia data may be transmitted from one point to another via a wireless optical link. In such embodiments, for example, a direct line of sight is needed between the two points in order to wirelessly “shoot” the optical signal from a transmitting module to a receiving module. For example, now referring to the exemplar embodiment shown in FIG. 7, an optical wireless transmission module comprises a fiber optic collimator and a two-axis optical mirror. In one or more embodiments, an optical wireless receiving module may be essentially the same as an optical transmission module. An optical beam coming off of an optical fiber 150 is collimated through a lens 152 and directed to the receiver by a two-axis mirror 154. After alignment, the beam may then be focused back to optical fiber 156 using a two-axis mirror 158 and via the lens 160 at the receiver end. Thus, in such a manner, a single fiber solution may be converted to an optical wireless connection. One or more of the two-axis mirrors 154, 158 may be controlled manually, or in one or more other embodiments, one or more of the mirrors 154, 158 may be controlled by an automated system. Further, it is noted that the optical wireless connection is not limited in terms of distance. For example, the distance between the transmitter and the receiver may be 0.5 meters to 10 meters, or even longer.

Advantages of the present invention may include one or more of the following. In one or more embodiments, an indoor digital multimedia solution may be implemented without having to purchase multiple ones of the same type of digital multimedia source.

In one or more embodiments, a digital multimedia source and an output device capable of playing content generated from the digital multimedia source may be remotely located from one another in an indoor setting.

In one or more embodiments, a digital multimedia source and an output device capable of playing content generated from the digital multimedia source may be remotely located from one another, yet operatively connected, via optical fiber cable.

In one or more embodiments, a digital multimedia source and an output device capable of playing content generated from the digital multimedia source may be remotely located from another in an indoor setting, yet operatively connected in a manner that is visually seamless to the non-suspecting human eye.

In one or more embodiments, a digital multimedia networking solution may be implemented using standards and protocols used by off-the-shelf digital multimedia components.

In one or more embodiments, an indoor digital multimedia network may use a single optical fiber to transmit uncompressed digital multimedia content.

In one or more embodiments, various digital multimedia sources located in an area of an indoor environment may be accessed from a different area of the indoor environment.

While the invention has been described with respect to a limited number of embodiments, those skilled in the art, having benefit of the above description, will appreciate that other embodiments may be devised which do not depart from the scope of the present invention as described herein. Accordingly, the scope of the present invention should be limited only by the appended claims.

What is claimed is:

1. An apparatus, comprising:
circuitry arranged to multiplex at least one of compressed and uncompressed digital data;
circuitry arranged to convert the multiplexed digital data to a signal capable of being transmitted over a single optical fiber; and
a connector operatively connected to the conversion circuitry and arranged to couple the signal to the single optical fiber.

2. The apparatus of claim 1, wherein the single optical fiber is housed in a substantially transparent jacket of an optical fiber cable.

3. The apparatus of claim 2, wherein the optical fiber cable has a thickness one of equal to or around 900 μm and equal to or around 1.6 mm.

4. The apparatus of claim 1, wherein the multiplexing circuitry is operatively connectable to a digital multimedia source from which digital data is received by the multiplexing circuitry.

5. The apparatus of claim 1, further comprising:
circuitry arranged to receive a user control signal.

6. The apparatus of claim 5, wherein the circuitry to receive the user control signal is operatively connected to an IR receiver.

7. The apparatus of claim 5, wherein the circuitry to receive the user control signal is operatively connected to a USB interface.

8. The apparatus of claim 1, further comprising:
circuitry arranged to recover a signal received from the single optical fiber.

9. The apparatus of claim 8, further comprising:
circuitry arranged to generate a digital multimedia signal based on the recovered signal, wherein the digital multimedia signal is usable by an output device for delivery of digital multimedia content.

10. A system, comprising:
a digital multimedia source arranged to generate a digital signal in response to reading a multimedia content medium; and
a dongle device operatively connected to the digital multimedia source and arranged to convert the digital signal to an optical signal, wherein the dongle device comprises a connector arranged to couple the optical signal to a substantially transparent optical fiber cable.

11. The system of claim 10, further comprising:
an output device operatively connected to the dongle device and arranged to render digital multimedia content based on the optical signal.

12. The system of claim 10, wherein the system is implemented in an indoor environment having a plurality of rooms, wherein the digital multimedia source is located in one of the plurality of rooms, and wherein the output device is located in another one of the plurality of rooms.

13. The system of claim 10, wherein the optical fiber cable comprises a single optical fiber.

14. The system of claim 10, wherein the digital multimedia source comprises one of a CD player, a DVD player, a set-top television box, a video game console, a personal computer console, a media center, and a camera.

15. The system of claim 10, wherein the output device comprises one of a television, a projector, a computer monitor, and an audio speaker.

16. The system of claim 10, wherein the dongle device is further arranged to receive a user control signal, and wherein the dongle device is further arranged to transmit the user control signal to the digital multimedia source.

17. The system of claim 16, wherein the user control signal is received from one of a keyboard, a mouse, a remote control, and a video game input device.

18. The system of claim 16, wherein the dongle device is further arranged to receive the user control signal via one an IR interface and a USB interface.

19. The system of claim 10, wherein the substantially transparent optical fiber cable has a thickness one of equal to or around 900 μm and equal to or around 1.6 mm.

20. The system of claim 10, wherein the optical signal comprises a video signal that is content protected.

21. A method of handling digital multimedia content, comprising:
inputting a digital signal from a digital multimedia source;
multiplexing the digital signal;
converting the digital signal to an optical signal; and
coupling the optical signal to a substantially transparent optical fiber cable for transmission of the optical signal to a location of an output device.

22. The method of claim 21, wherein the optical signal comprises at least one of an uncompressed video signal, an uncompressed audio signal, a compressed video signal, and a compressed audio signal.

23. The method of claim 21, wherein the optical fiber cable comprises a single optical fiber.

24. The method of claim 21, wherein the digital multimedia source comprises one of a CD player, a DVD player, a set-top television box, a video game console, a personal computer console, and a media center.

25. The method of claim 21, wherein the output device comprises one of a television, a projector, a computer monitor, and an audio speaker.

26. A method of handling digital multimedia content, comprising:
reading a digital content medium;
generating with a digital multimedia source a digital signal in response to the reading;
converting the digital signal to an optical signal;
coupling the optical signal to a substantially transparent optical fiber cable, the optical fiber cable capable of carrying the optical signal to an output device disposed in a location remote from a location of the digital multimedia source;
receiving from the optical fiber cable a user control signal initiated by a user in response to digital multimedia content rendered by the output device; and
modifying the digital signal with the digital multimedia source in response to the user control signal.

27. The method of claim 26, wherein the optical fiber cable comprises a single optical fiber.

28. The method of claim 26, wherein the digital multimedia source comprises one of a CD player, a DVD player, a set-top television box, a video game console, a personal computer console, and a media center.

29. The method of claim 26, wherein the output device comprises one of a television, a projector, a computer monitor, and an audio speaker.

30. The method of claim 26, wherein the digital content medium is any one of a DVD, a CD, a video game, digital television data, a computer hard drive, and computer memory.

31. The method of claim 26, wherein the optical signal comprises at least one of an uncompressed video signal, an uncompressed audio signal, a compressed audio signal, and a compressed video signal.

32. The method of claim 26, wherein the substantially transparent optical fiber cable has a thickness one of equal to or around 900 μm and equal to or around 1.6 mm.
